(19) United States
(12) Patent Application Publication
(10) Pub. No.: US 2025/0233975 A1
(43) Pub. Date: Jul. 17, 2025

(54) VIDEO COMMUNICATION METHOD AND DEVICE

(71) Applicant: BOE TECHNOLOGY GROUP CO., LTD., Beijing (CN)

(72) Inventors: Wenyu Li, Beijing (CN); Lili Chen, Beijing (CN); Jinghua Miao, Beijing (CN)

(21) Appl. No.: 18/294,691

(22) PCT Filed: Feb. 20, 2023
(86) PCT No.: PCT/CN2023/077088

§ 371 Date: Feb. 2, 2024

(51) Int. Cl. H04N 13/383; H04N 13/194

(52) U.S. Cl. CPC H04N 13/383; H04N 13/194

(57) ABSTRACT

The present application proposes a video communication method, including obtaining human eye positioning coordinate data of a viewer acquired at a display terminal, wherein the human eye positioning coordinate data includes a horizontal coordinate of the left eye and a horizontal coordinate of the right eye of the viewer in the display space of the display terminal, acquiring a current frame scene image of a scene located at the acquisition terminal, rendering a left-eye viewpoint map at a viewpoint corresponding to the horizontal coordinate of the left eye and a right-eye viewpoint map at a viewpoint corresponding to the horizontal coordinate of the right eye in the display space according to the current frame scene image and the human eye positioning coordinate data, transmitting rendered left-eye viewpoint map and right-eye viewpoint map to the display terminal so as to perform display at the display terminal.

### RELATED APPLICATIONS

The present application is a 35 U.S.C. 371 national stage application of PCT International Application No. PCT/CN2023/077088 filed on Feb. 20, 2023, the entire disclosure of which is incorporated herein by reference.

### FIELD

The present disclosure relates to the technical field of video communication, in particular to a video communication method, a video communication device, a computing device, a computer storage medium, and a computer program product.

### BACKGROUND

In recent years, with the rapid development of 3D (3 dimensions) display technology, especially the rapid progress in naked-eye 3D display technology, 3D display technology has been widely adopted in global video conferences. Due to the strong immersively interactive experience of 3D remote one-on-one video communication, it can be foreseen as the mainstream communication method in the future.

For such a video communication system, it is generally necessary to use a large number of cameras to acquire multi-angle data of the scene in front of the screen, in order to serve as the source data for later 3D image information synthesis. The traditional method is to use a graphics card to encode the acquired source data in hardware and then push it to the network, and then the display terminal obtains the encoded data from the network for decoding and rendering. However, for a multi-camera system, this method requires multiple GPU hardware encoding/decoding chips, and transmission of a large amount of encoded data of multiple cameras has high requirements on network transmission and server bandwidth. Therefore, this video communication method involves a high hardware cost, a high data transmission cost, and a high hardware power consumption.

### SUMMARY

In view of this, the present disclosure provides a video communication method and device, a computing device, a computer storage medium, and a computer program product.

According to a first aspect of the present disclosure, there is provided a video communication method applied to an acquisition terminal, comprising: obtaining human eye positioning coordinate data of a viewer acquired at a display terminal, wherein the human eye positioning coordinate data comprises a horizontal coordinate of a left eye and a horizontal coordinate of a right eye of the viewer in a display space of the display terminal; acquiring a current frame scene image of a scene located at the acquisition terminal; rendering a left-eye viewpoint map at a viewpoint corresponding to the horizontal coordinate of the left eye and a right-eye viewpoint map at a viewpoint corresponding to the horizontal coordinate of the right eye in the display space according to the current frame scene image and the human eye positioning coordinate data; transmitting rendered left-eye viewpoint map and right-eye viewpoint map to the display terminal, so as to perform display at the display terminal according to the rendered left-eye viewpoint map and right-eye viewpoint map.

In some embodiments, said acquiring a current frame scene image of a scene located at the acquisition terminal comprises: acquiring current frame color images of the scene and current frame depth images of the scene at multiple different viewing angles of the acquisition terminal.

In some embodiments, the human eye positioning coordinate data of the viewer is acquired by: obtaining a human eye image comprising the left eye and the right eye of the viewer in the display space of the display terminal; detecting, in the human eye image, regions of interest comprising the left eye and the right eye respectively to obtain a left-eye region image and a right-eye region image; denoising the left-eye region image and the right-eye region image to obtain a left-eye denoised image and a right-eye denoised image; performing a gradient calculation on the left-eye denoised image and the right-eye denoised image, respectively, and determining a horizontal coordinate of a point with a largest number of straight line intersections in a gradient direction in a respective denoised image of the left-eye denoised image and the right-eye denoised image as a horizontal coordinate of an eye of the viewer in a respective direction.

In some embodiments, said rendering a left-eye viewpoint map at a viewpoint corresponding to the horizontal coordinate of the left eye and a right-eye viewpoint map at a viewpoint corresponding to the horizontal coordinate of the right eye in the display space according to the current frame scene image and the human eye positioning coordinate data comprises: inputting the current frame scene image and the human eye positioning coordinate data into a trained viewpoint map generation model to obtain a left-eye viewpoint map at a viewpoint corresponding to the horizontal coordinate of the left eye and a right-eye viewpoint map at a viewpoint corresponding to the horizontal coordinate of the right eye in the display space. The trained viewpoint map generation model is obtained by: obtaining a training set, the training set comprising a plurality of sample groups, each sample group comprising a sample scene image, a horizontal coordinate of a sample human eye, and a corresponding target viewpoint map at a viewpoint corresponding to the horizontal coordinate of the sample human eye in the display space; inputting the sample scene image and the horizontal coordinate of the sample human eye in each sample group into an initial viewpoint map generation model to obtain a corresponding predicted viewpoint map at a viewpoint corresponding to the horizontal coordinate of the sample human eye in the display space; adjusting the initial viewpoint map generation model to minimize an error between a target viewpoint map and a predicted viewpoint map corresponding to each sample group, thereby obtaining the trained viewpoint map generation model.

In some embodiments, the human eye positioning coordinate data of the viewer is acquired at the display terminal at a first moment, and the method further comprises: according to the current frame scene image, horizontal coordinates corresponding to multiple left eye viewpoints and horizontal coordinates corresponding to multiple right eye viewpoints, rendering left-eye viewpoint maps at the multiple left eye viewpoints and right-eye viewpoint maps at the multiple right eye viewpoints in the display space, wherein horizontal coordinates to which a portion of left eye viewpoints of the multiple left eye viewpoints correspond are smaller than the horizontal coordinate of the left eye, and horizontal coordinates to which the other portion of left eye viewpoints correspond are larger than the horizontal coordinate of the left eye, and wherein horizontal coordinates to which a portion of right eye viewpoints of the multiple right eye viewpoints correspond are smaller than the horizontal coordinate of the right eye, and horizontal coordinates to which the other portion of right eye viewpoints correspond are larger than the horizontal coordinate of the right eye. Said transmitting rendered left-eye viewpoint map and right-eye viewpoint map to the display terminal, so as to perform display at the display terminal according to the rendered left-eye viewpoint map and right-eye viewpoint map comprises: transmitting the rendered left-eye viewpoint map and right-eye viewpoint map to the display terminal, so as to determine, based on human eye positioning coordinate data acquired at a second moment after the first moment, viewpoint maps at viewpoints corresponding to the human eye positioning coordinate data acquired at the second moment from the rendered left-eye viewpoint maps and right-eye viewpoint maps for display.

In some embodiments, a number of said portion of left eye viewpoints depends on a moving distance between a horizontal coordinate of the left eye acquired at the second moment and a horizontal coordinate of the left eye acquired at the first moment during a previous frame period, the previous frame period represents a process of determining a viewpoint map at a corresponding viewpoint for display using a previous frame scene image before the current frame scene image.

In some embodiments, the number of said portion of left eye viewpoints is determined by: determining a moving distance between a horizontal coordinate of the left eye acquired at the second moment and a horizontal coordinate of the left eye acquired at the first moment during a previous frame period; dividing the moving distance by a spacing between adjacent viewpoints of a display presenting the display space to obtain a distance ratio; in response to the distance ratio being an integer, determining the distance ratio as the number of said portion of left eye viewpoints; in response to the distance ratio not being an integer, determining a minimum positive integer larger than the distance ratio as the number of said portion of left eye viewpoints.

In some embodiments, a number of left-eye viewpoint maps at the multiple left eye viewpoints is equal to a number of right-eye viewpoint maps at the multiple right eye viewpoints, a number of said portion of left eye viewpoints is equal to a number of said other portion of left eye viewpoints, and a number of said portion of right eye viewpoints is equal to a number of said other portion of right eye viewpoints. Said portion of the left eye viewpoints and said other portion of the left eye viewpoints comprise viewpoints adjacent to the viewpoint corresponding to the horizontal coordinate of the left eye, respectively, and are arranged successively according to a sequence of viewpoints in the display space; said portion of right eye viewpoints and said other portion of right eye viewpoints comprise viewpoints adjacent to the viewpoint corresponding to the horizontal coordinate of the right eye, respectively, and are arranged successively according to the sequence of viewpoints in the display space.

According to a second aspect of the present disclosure, there is provided a video communication method applied to a display terminal, comprising: acquiring human eye positioning coordinate data of a viewer located at a display terminal, wherein the human eye positioning coordinate data comprises a horizontal coordinate of a left eye and a horizontal coordinate of a right eye of the viewer in a display space of the display terminal; transmitting the human eye positioning coordinate data to an acquisition terminal; obtaining left-eye viewpoint maps and right-eye viewpoint maps, the left-eye viewpoint maps comprising a left-eye viewpoint map at a viewpoint corresponding to the horizontal coordinate of the left eye in the display space, rendered by the acquisition terminal according to a current frame scene image acquired by the acquisition terminal and the human eye positioning coordinate data, the right-eye viewpoint maps comprising a right-eye viewpoint map at a viewpoint corresponding to the horizontal coordinate of the right eye in the display space, rendered by the acquisition terminal according to the current frame scene image acquired by the acquisition terminal and the human eye positioning coordinate data; performing display according to the obtained left-eye viewpoint maps and right-eye viewpoint maps.

In some embodiments, the current frame scene image acquired by the acquisition terminal comprises current frame color images of the scene and current frame depth images of the scene acquired at multiple different viewing angles of the acquisition terminal.

In some embodiments, said acquiring human eye positioning coordinate data of a viewer located at a display terminal comprises: obtaining a human eye image comprising the left eye and the right eye of the viewer in the display space of the display terminal; detecting, in the human eye image, regions of interest comprising the left eye and the right eye respectively to obtain a left-eye region image and a right-eye region image; denoising the left-eye region image and the right-eye region image to obtain a left-eye denoised image and a right-eye denoised image; performing a gradient calculation on the left-eye denoised image and the right-eye denoised image, respectively, and determining a horizontal coordinate of a point with a largest number of straight line intersections in a gradient direction in a respective denoised image of the left-eye denoised image and the right-eye denoised image as a horizontal coordinate of an eye of the viewer in a respective direction.

In some embodiments, the human eye positioning coordinate data of the viewer is acquired at a first moment, and the left-eye viewpoint map further comprises left-eye viewpoint maps at multiple left eye viewpoints and the right-eye viewpoint map further comprises right-eye viewpoint maps at multiple right eye viewpoints, wherein horizontal coordinates to which a portion of left eye viewpoints of the multiple left eye viewpoints correspond are smaller than the horizontal coordinate of the left eye, and horizontal coordinates to which the other portion of left eye viewpoints correspond are larger than the horizontal coordinate of the left eye, and wherein horizontal coordinates to which a portion of right eye viewpoints of the multiple right eye viewpoints correspond are smaller than the horizontal coordinate of the right eye, and horizontal coordinates to which the other portion of right eye viewpoints correspond are larger than the horizontal coordinate of the right eye. Said performing display according to the obtained left-eye viewpoint maps and right-eye viewpoint maps comprises: determining, based on human eye positioning coordinate data acquired at a second moment after the first moment, viewpoint maps at viewpoints corresponding to the human eye positioning coordinate data acquired at the second moment from the rendered left-eye viewpoint maps and right-eye viewpoint maps for display.

In some embodiments, a number of said portion of left eye viewpoints depends on a moving distance between a horizontal coordinate of the left eye acquired at the second moment and a horizontal coordinate of the left eye acquired at the first moment during a previous frame period, the previous frame period represents a process of determining a viewpoint map at a corresponding viewpoint for display using a previous frame scene image before the current frame scene image.

In some embodiments, the method further comprises: determining the number of said portion of left eye viewpoints by: determining a moving distance between a horizontal coordinate of the left eye acquired at the second moment and a horizontal coordinate of the left eye acquired at the first moment during a previous frame period; dividing the moving distance by a spacing between adjacent viewpoints of a display presenting the display space to obtain a distance ratio; in response to the distance ratio being an integer, determining the distance ratio as the number of said portion of left eye viewpoints; in response to the distance ratio not being an integer, determining a minimum positive integer larger than the distance ratio as the number of said portion of left eye viewpoints.

In some embodiments, a number of left-eye viewpoint maps at the multiple left eye viewpoints is equal to a number of right-eye viewpoint maps at the multiple right eye viewpoints, a number of said portion of left eye viewpoints is equal to a number of said other portion of left eye viewpoints, and a number of said portion of right eye viewpoints is equal to a number of said other portion of right eye viewpoints. Said portion of the left eye viewpoints and said other portion of the left eye viewpoints comprise viewpoints adjacent to the viewpoint corresponding to the horizontal coordinate of the left eye, respectively, and are arranged successively according to a sequence of viewpoints in the display space; said portion of right eye viewpoints and said other portion of right eye viewpoints comprise viewpoints adjacent to the viewpoint corresponding to the horizontal coordinate of the right eye, respectively, and are arranged successively according to the sequence of viewpoints in the display space.

In some embodiments, said determining, based on human eye positioning coordinate data acquired at a second moment after the first moment, viewpoint maps at viewpoints corresponding to the human eye positioning coordinate data acquired at the second moment from the rendered left-eye viewpoint maps and right-eye viewpoint maps for display comprises: determining a first horizontal coordinate closest to the horizontal coordinate of the left eye acquired at the second moment from horizontal coordinates corresponding to the rendered left-eye viewpoint maps, and a second horizontal coordinate closest to the horizontal coordinate of the right eye acquired at the second moment from horizontal coordinates corresponding to the rendered right-eye viewpoint maps; determining a left-eye viewpoint map to which the first horizontal coordinate corresponds and a right-eye viewpoint map to which the second horizontal coordinate corresponds as the viewpoint maps at viewpoints corresponding to the human eye positioning coordinate data acquired at the second moment for display.

According to a third aspect of the present disclosure, there is provided a video communication device applied to an acquisition terminal, comprising: a coordinate data obtaining module configured to obtain human eye positioning coordinate data of a viewer acquired at a display terminal, wherein the human eye positioning coordinate data comprises a horizontal coordinate of a left eye and a horizontal coordinate of a right eye of the viewer in a display space of the display terminal; a scene image acquisition module configured to acquire a current frame scene image of a scene located at the acquisition terminal; a viewpoint map rendering module configured to render, according to the current frame scene image and the human eye positioning coordinate data, a left-eye viewpoint map at a viewpoint corresponding to the horizontal coordinate of the left eye, and a right-eye viewpoint map at a viewpoint corresponding to the horizontal coordinate of the right eye in the display space; a viewpoint map transmission module configured to transmit rendered left-eye viewpoint map and right-eye viewpoint map to the display terminal, so as to perform display at the display is terminal according to the rendered left-eye viewpoint map and right-eye viewpoint map.

According to a fourth aspect of the present disclosure, there is provided a video communication device applied to a display terminal, comprising: a coordinate data acquisition module configured to acquire human eye positioning coordinate data of a viewer located at the display terminal, wherein the human eye positioning coordinate data comprises a horizontal coordinate of a left eye and a horizontal coordinate of a right eye of the viewer in a display space of the display terminal; a coordinate data transmission module configured to transmit the human eye positioning coordinate data to an acquisition terminal; a viewpoint map obtaining module configured to obtain left-eye viewpoint maps and right-eye viewpoint maps, the left-eye viewpoint maps comprising a left-eye viewpoint map at a viewpoint corresponding to the horizontal coordinate of the left eye in the display space, rendered by the acquisition terminal according to a current frame scene image acquired by the acquisition terminal and the human eye positioning coordinate data, the right-eye viewpoint maps comprising a right-eye viewpoint map at a viewpoint corresponding to the horizontal coordinate of the right eye in the display space, rendered by the acquisition terminal according to the current frame scene image acquired by the acquisition terminal and the human eye positioning coordinate data; a viewpoint map display module configured to perform display according to the obtained left-eye viewpoint maps and right-eye viewpoint maps.

According to a fifth aspect of the present disclosure, there is provided a computing device, comprising a memory and a processor, the memory storing a computer program which, when executed by the processor, causes the processor to carry out steps of any of the methods described above.

According to a sixth aspect of the present disclosure, there is provided a storage medium, the computer-readable storage medium storing a computer program which, when executed by a processor, causes the processor to execute any of the methods described above.

According to a seventh aspect of the present disclosure, there is provided a computer program product comprising a computer program which, when executed by a processor, implements steps of any of the methods described above.

In the video communication method and device claimed in the present disclosure, the acquisition terminal obtains the human eye positioning coordinate data of the viewer acquired at the display terminal, renders a left-eye viewpoint map at a viewpoint corresponding to the horizontal coordinate of the left eye and a right-eye viewpoint map at a viewpoint corresponding to the horizontal coordinate of the right eye in the display space based on the current frame scene image of the scene located at the acquisition terminal acquired by the acquisition terminal and the human eye positioning coordinate data, and then transmits rendered left-eye viewpoint map and right-eye viewpoint map to the display terminal, so as to perform display at the display terminal according to the rendered left-eye viewpoint map and right-eye viewpoint map. This makes it only necessary to render corresponding viewpoint maps for the left and right eyes at the acquisition terminal and transmit them to the display terminal, so as to perform display at the display terminal according to the rendered left-eye viewpoint map and right-eye viewpoint map. In this way, since only partial viewpoint maps are rendered at the acquisition terminal, the data amount of the rendered viewpoint maps is greatly smaller than the data amount of the scene maps captured by all cameras. Therefore, this technical solution does not require encoding/decoding and transmission of a large amount of data acquired by multiple cameras, thereby reducing needs for hardware such as GPU, decreasing the cost of data transmission (e.g., decreasing the requirements on network bandwidth and server bandwidth), and greatly reducing the power consumption of hardware.

These and other advantages of the present disclosure will be apparent from and set forth with reference to the embodiments described below.

### BRIEF DESCRIPTION OF THE DRAWINGS

Embodiments of the present disclosure will now be described in more detail and with reference to the accompanying drawings, wherein

FIG. 1 illustrates a schematic view of an architecture of a video communication system;

FIG. 2 illustrates a schematic flow chart of a video communication method in the related art;

FIG. 3 illustrates a schematic flow chart of a video communication method according to an embodiment of the present disclosure;

FIG. 4 illustrates an exemplary architectural diagram of a viewpoint map generation model according to one embodiment of the present disclosure;

FIG. 5 illustrates an exemplary arrangement of left-eye viewpoint maps;

FIG. 6 illustrates a schematic flow chart of a video communication method according to an embodiment of the present disclosure;

FIG. 7 illustrates an exemplary method of acquiring human eye positioning coordinate data at the display terminal;

FIG. 8A illustrates a pixel arrangement viewpoint map within a single period;

FIG. 8B illustrates a pixel arrangement viewpoint map within multiple periods;

FIG. 9 illustrates a schematic flow chart of a video communication method according to an embodiment of the present disclosure;

FIG. 10 illustrates an exemplary structural block diagram of a video communication device according to an embodiment of the present disclosure;

FIG. 11 illustrates an exemplary structural block diagram of a video communication device according to another embodiment of the present disclosure;

FIG. 12 illustrates an exemplary system comprising an exemplary computing device representative of one or more systems and/or devices that can implement various techniques described herein.

### DETAILED DESCRIPTION

Specific details of embodiments of the present disclosure will be described below to enable those skilled in the art to fully understand and implement the embodiments of the present disclosure. It should be understood that the technical solution of the present disclosure may be implemented without some of these details. In some cases, the present disclosure does not show or describe well-known structures or functions in detail to avoid unnecessary description from obscuring the description of the embodiments of the present disclosure. The terms used in the present disclosure should be understood in their broadest reasonable manner, even if used in connection with specific embodiments of the present disclosure.

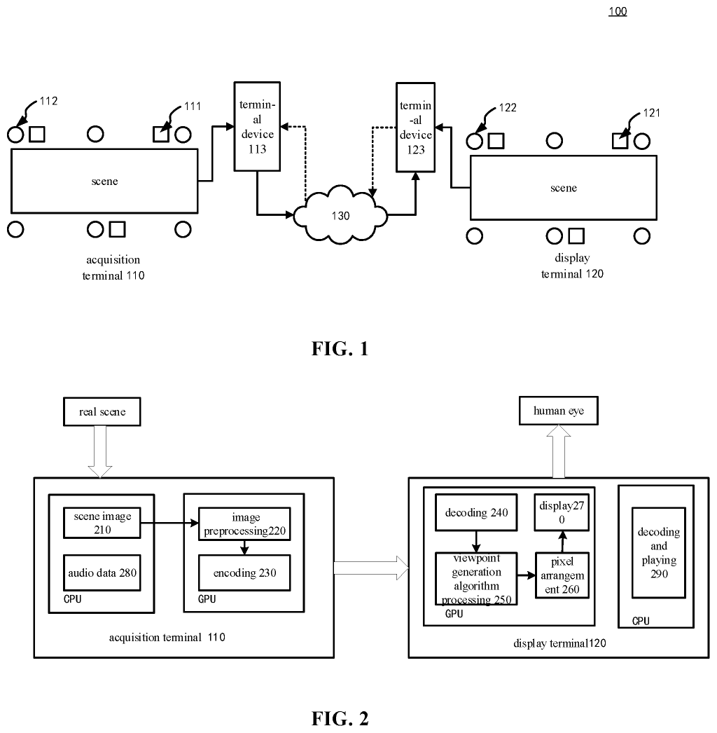

FIG. 1 illustrates a schematic view of an architecture 100 of a video communication system in which the technical solution of the present disclosure and the technical solution of the related art can be implemented. As shown in FIG. 1, the architecture 100 comprises an acquisition terminal 110, a display terminal 120 and a network 130. With this architecture, the user at the acquisition terminal 110 can perform video communication with the user at the display terminal 120, for example, 3D video communication, holographic video communication, etc.

The acquisition terminal 110 comprises multiple microphones 111, multiple cameras 112 and a terminal device 113. Similarly, the display terminal comprises multiple microphones 121, multiple cameras 122 and a terminal device 123. As an example, during video communication, the multiple cameras 112 can acquire images of the scene located at the acquisition terminal. The acquired images are processed (e.g., encoded, etc.) by the terminal device 113 and transmitted to the display terminal via the network 130 for display at the display terminal, so that the user at the display terminal is able to participate in video communication immersively, thereby realizing video communication.

It is to be noted that the acquisition terminal and the display terminal described above are just specified as examples for the convenience of description, but are not restrictive. In fact, the display terminal may also be used as an acquisition terminal to acquire images of its scene, and the acquisition terminal may also be used as a display terminal to view the display. In addition, only the way of processing images acquired by the cameras is described here, while processing of audio data acquired by the microphones 121 is omitted, because audios can be processed in any appropriate manner, as long as they are synchronized with images.

The aforementioned terminal device 113 may include, but is not limited to, at least one of a mobile phone, a tablet computer, a notebook computer, a desktop PC, a digital television, and other computing devices or terminals with processing capability. The network 130 may be, for example, a wide area network (WAN), a local area network (LAN), a wireless network, a public telephone network, an intranet, and any other type of network well known to those skilled in the art. It is also to be noted that the scenario described above is only an example in which embodiments of the present disclosure may be implemented, and is not restrictive.

FIG. 2 illustrates a schematic flow chart of a video communication method in the related art. The method may be implemented in the architecture of the video communication system described with reference to FIG. 1.

As shown in FIG. 2, after the camera 112 of the acquisition terminal 110 has acquired a scene image 210 of the acquisition terminal, it is first transmitted to the CPU (central processing unit) of the terminal device 113. The CPU then transmits the data to, for example, the GPU (graphics processing unit) of the terminal device. The GPU first performs image preprocessing 220 such as color correction and frame interpolation on the acquired scene image data to obtain RGB data, and then directly uses a GPU hardware encoding chip to perform encoding 230 of the RGB data. The encoded data obtained from encoding is uploaded to network 130. The CPU of the display terminal 120 pulls in the encoded data from the network 130 and performs decoding 240 through the GPU hard decoding chip to obtain the scene image data acquired by the camera of the acquisition terminal. At the same time, human eye positioning coordinate data (for example, the horizontal coordinate of the left eye and the horizontal coordinate of the right eye in the display space of the display terminal) of the viewer can be acquired. The scene image data can be processed 250 by, for example, a viewpoint generation algorithm so as to obtain from the scene image data a viewpoint map of a position that human eyes at the display terminal are viewing according to the human eye positioning coordinates of the viewer. Pixel arrangement 260 is performed again in combination with a light field display and display 270 is outputted. Of course, this process further comprises processing of audio data 280, and performing decoding and playing 290 synchronously with the viewpoint map at the display terminal, which will not be described in detail here.

This video communication method is classical and traditional. However, for a multi-camera system, especially when the multiple cameras are ultra-high-resolution acquisition cameras, the cameras acquire a large amount of data, which requires a super powerful graphics card or hardware codec chips of multiple graphics cards to cooperate. This results in a high hardware cost, a high data transmission cost, and a high power consumption of hardware.

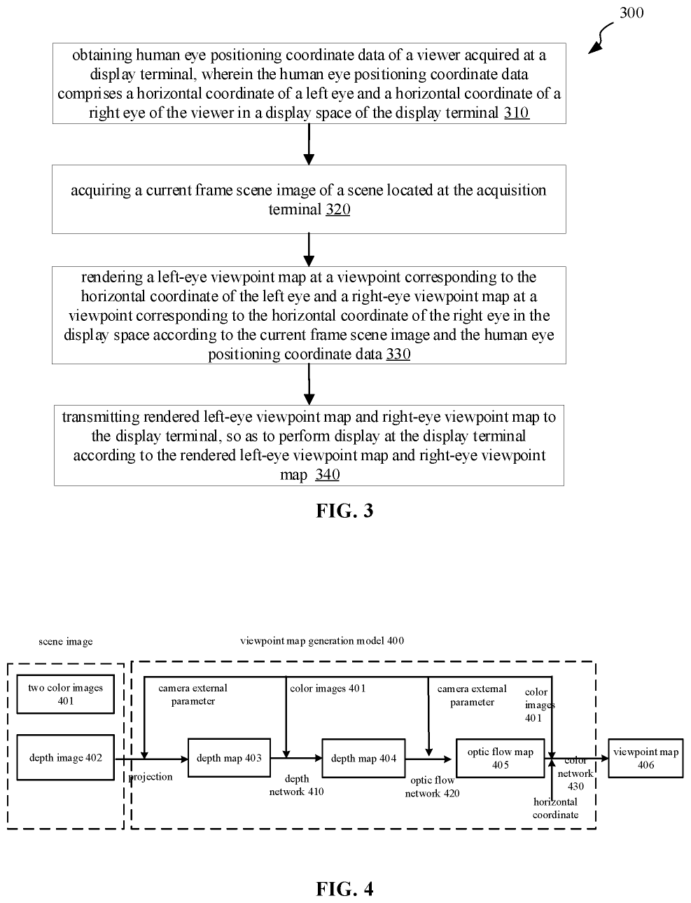

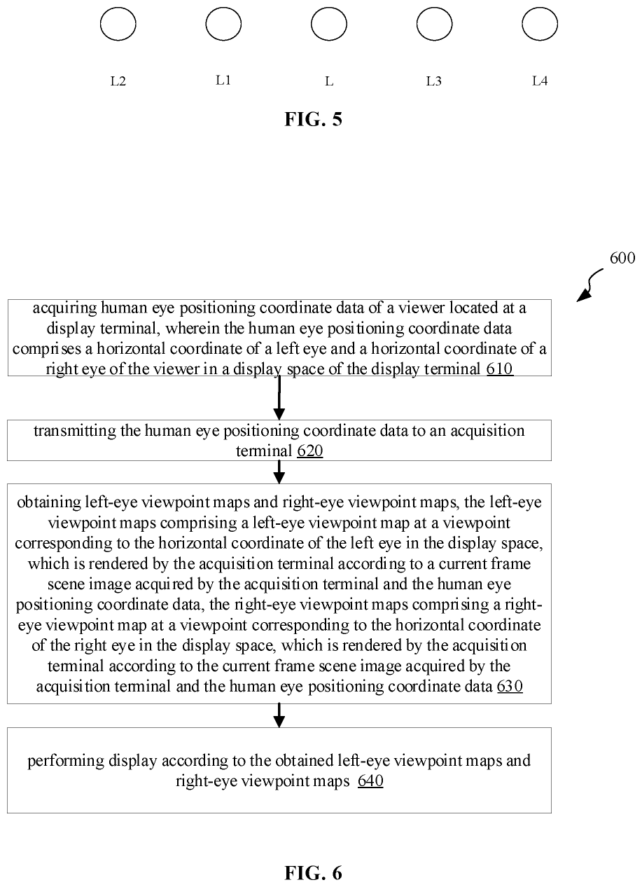

FIG. 3 illustrates a schematic flow chart of a video communication method 300 according to an embodiment of the present disclosure. The method 300 may also be implemented in the architecture of the video communication system described with reference to FIG. 1, and may be applied at the acquisition terminal. The video communication here may be, for example, holographic video communication or the like. The method 300 comprises the following steps.

In step 310, human eye positioning coordinate data of a viewer acquired at the display terminal is obtained, wherein the human eye positioning coordinate data comprises a horizontal coordinate of the left eye and a horizontal coordinate of the right eye of the viewer in the display space of the display terminal. The display space here may be, for example, a three-dimensional display space. Usually, the viewer views displayed content at the display terminal through a three-dimensional display or display device, so that the viewer is in a virtual display space. The human eye positioning coordinate data of the viewer can be acquired at the display terminal, and the acquired human eye positioning coordinate data of the viewer can be obtained at the acquisition terminal. As an example, the horizontal direction here is the same as the arrangement direction of viewpoints of the three-dimensional display or display device, i.e., being the same as the horizontal direction or the lateral direction of the three-dimensional display or display device.

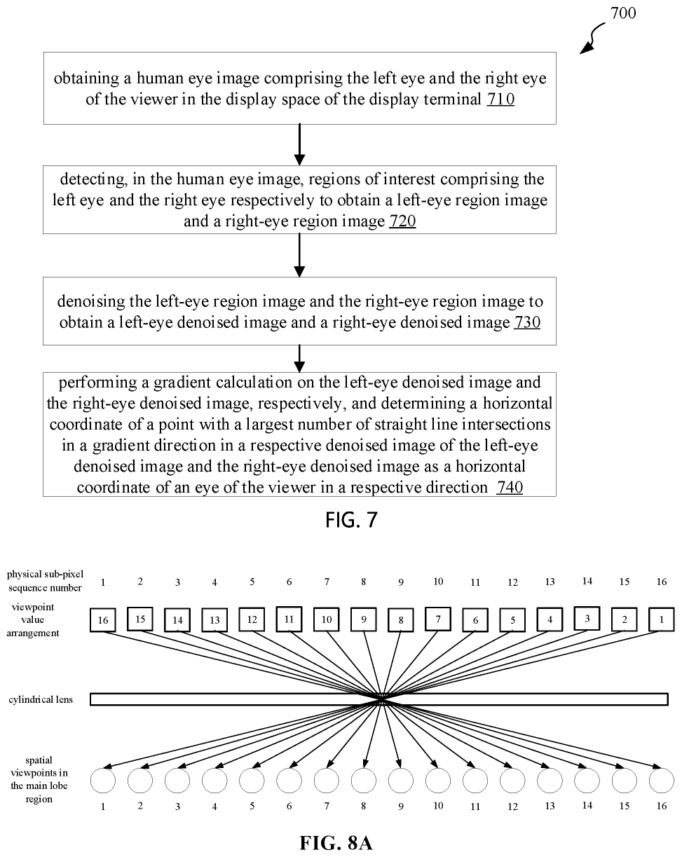

As an example, the human eye positioning coordinate data can be acquired at the display terminal in the following manner. For example, a human eye image including the left eye and the right eye of the viewer in the display space of the display terminal may be first obtained. Then, regions of interest including the left eye and the right eye respectively are detected in the human eye image to obtain a left-eye region image and a right-eye region image. Next, the left-eye region image and the right-eye region image are denoised to obtain a left-eye denoised image and a right-eye denoised image. Finally, a gradient calculation is performed on the left-eye denoised image and the right-eye denoised image, respectively, the horizontal coordinate of a point with the largest number of straight line intersections in the gradient direction in the left-eye denoised image as a horizontal coordinate of the left eye of the viewer, and the horizontal coordinate of a point with the largest number of intersections of straight lines in the gradient direction in the right-eye denoised image is determined as a horizontal coordinate of the right eye of the viewer. This enables precise acquisition of human eye positioning coordinate data, which will be further explained later with reference to FIG. 7.

In step 320, a current frame scene image of a scene located at the acquisition terminal is acquired. In some embodiments, at the time of acquiring the current frame scene image of the scene located at the acquisition terminal, a current frame color image of the scene and a current frame depth image of the scene may be acquired at multiple different viewing angles of the acquisition terminal, that is, the current frame scene image may include multiple current frame color images and one or more current frame depth images of the scene. “Multiple” here may refer to two or more. The current frame refers to a scene image that matches the most recently received human eye positioning coordinate data. The matching here can be achieved as follows: while acquiring the current frame scene image, the human eye positioning coordinate data of the viewer acquired at the display terminal is obtained simultaneously to achieve matching; or the human eye positioning coordinate data of the viewer acquired at the display terminal may be obtained first, and the current frame scene image of the scene located at the acquisition terminal is acquired in the most recent time to achieve matching, which will not be limited here.

In step 330, according to the current frame scene image and the human eye positioning coordinate data, a left-eye viewpoint map at a viewpoint corresponding to the horizontal coordinate of the left eye and a right-eye viewpoint map at a viewpoint corresponding to the horizontal coordinate of the right eye in the display space are rendered. Various methods may be used to render a left-eye viewpoint map at a viewpoint corresponding to the horizontal coordinate of the left eye and a right-eye viewpoint map at a viewpoint corresponding to the horizontal coordinate of the right eye in the display space. For example, it is possible to first perform space reconstruction (for example, three-dimensional space reconstruction) according to the current frame scene image to obtain an overall spatial map of the display space, and then render a left-eye viewpoint map at a viewpoint corresponding to the horizontal coordinate of the left eye and a right-eye viewpoint map at a viewpoint corresponding to the horizontal coordinate of the right eye in the display space according to the human eye positioning coordinate data. For another example, frame interpolation may be performed on the current frame scene image according to the human eye positioning coordinate data, thereby rendering a left-eye viewpoint map at a viewpoint corresponding to the horizontal coordinate of the left eye and a right-eye viewpoint map at a viewpoint corresponding to the horizontal coordinate of the right eye in the display space.

In some embodiments, a deep learning network may also be used for rendering, that is, the current frame scene image and the human eye positioning coordinate data are inputted into a trained viewpoint map generation model to obtain a left-eye viewpoint map at a viewpoint corresponding to the horizontal coordinate of the left eye and a right-eye viewpoint map at a viewpoint corresponding to the horizontal coordinate of the right eye in the display space. The trained viewpoint map generation model is trained in any appropriate manner. As an example, it can be trained in the following manner. Firstly, a training set is obtained. The training set includes multiple sample groups. Each sample group includes a sample scene image, a horizontal coordinate of a sample human eye, and a corresponding target viewpoint map at a viewpoint corresponding to the horizontal coordinate of the sample human eye in the display space. Secondly, the sample scene image and the horizontal coordinate of the sample human eye in each sample group are inputted into an initial viewpoint map generation model to obtain a corresponding predicted viewpoint map at a viewpoint corresponding to the horizontal coordinate of the sample human eye in the display space. Thirdly, the initial viewpoint map generation model is adjusted to minimize an error between the target viewpoint map and the predicted viewpoint map to which each sample group corresponds, thereby obtaining the trained viewpoint map generation model. This provides a method for efficiently training a viewpoint map generation model.

As an example, FIG. 4 illustrates an exemplary architectural diagram of a viewpoint map generation model 400 according to an embodiment of the present disclosure. FIG. 4 is described based on an example in which the current scene image includes two color images 401 (for example, RGB images) taken from different viewing angles and one depth image 402. This is just an example. In fact, in actual scenes, color images from more angles are required. The viewpoint map generation model 400 comprises a depth network 410, an optic flow network 420, and a color network 430, which is a three-portion network structure. As shown in FIG. 4, after two color images 401 and one depth image 402 are processed by the three-portion network structure, a required viewpoint map 406 (which may be a left-eye viewpoint map or a right-eye viewpoint map correspondingly according to the input horizontal coordinate of the left eye or the input horizontal coordinate of the right eye) is finally outputted. Specifically, by using a projection matrix composed of camera external parameters to project the input depth image 402, two relatively rough depth maps 403 corresponding to the input color images can be obtained. After the two depth maps 403 and color images 401 are processed by the deep network 410, two depth maps 404 with higher accuracy can be outputted. The depth maps 404 are combined with the camera external parameters to serve as an input to the optic flow network, and an output is two optic flow maps 405 (an optic flow is a movement pattern of objects, surfaces and edges in a visual scene caused by a relative movement between the observer and the scene. Generally, an optic flow is generated by a movement of the foreground object itself in the scene, a movement of the observer, or movements of both). The optic flow maps 405, the two color images 401, and the horizontal coordinate of the left eye or the horizontal coordinate of the right eye are used as inputs to the color network, and a corresponding viewpoint map 406 is outputted.

In step 340, the rendered left-eye viewpoint map and right-eye viewpoint map are transmitted to the display terminal, so as to perform display at the display terminal according to the rendered left-eye viewpoint map and right-eye viewpoint map. For example, the rendered left-eye viewpoint map and right-eye viewpoint map are displayed to the left eye and the right eye of the viewer respectively, so as to obtain a three-dimensional display experience.

In some embodiments, when the rendered left-eye viewpoint map and right-eye viewpoint map are transmitted to the display terminal, the human eye positions may have changed and are no longer at the original horizontal coordinates, which results in changes in the viewing angles of the human eyes. For example, the human eye positioning coordinate data of the viewer is acquired at the display terminal at a first moment, and after the rendered left-eye viewpoint map and right-eye viewpoint map are transmitted to the display terminal, the human eye positioning coordinates of the viewer are acquired again at a second moment so as to determine whether the human eye positions have changed. In order to be able to cope with the situation where changes have occurred, the method may further comprise the steps of: rendering left-eye viewpoint maps at multiple left eye viewpoints and right-eye viewpoint maps at multiple right eye viewpoints in the display space according to the current frame scene image, the horizontal coordinates corresponding to the multiple left eye viewpoints and the horizontal coordinates corresponding to the multiple right eye viewpoints, wherein the horizontal coordinates to which a portion of left eye viewpoints of the multiple left eye viewpoints correspond are smaller than the horizontal coordinate of the left eye, and the horizontal coordinates to which the other portion of left eye viewpoints correspond are greater than the horizontal coordinate of the left eye, and wherein the horizontal coordinates to which a portion of right eye viewpoints of the multiple right eye viewpoints correspond are smaller than the horizontal coordinate of the right eye, and the horizontal coordinates to which the other portion of right eye viewpoints correspond are greater than the horizontal coordinate of the right eye. The left eye viewpoint here is a viewpoint in the display space, not the left eye, thus the horizontal coordinate to which the left eye viewpoint corresponds is also different from the horizontal coordinate of the left eye. Similarly, the horizontal coordinate to which the right eye viewpoint corresponds is also different from the horizontal coordinate of the right eye. This step may be performed synchronously with step 330, for example. Correspondingly, when the rendered left-eye viewpoint map and right-eye viewpoint map are transmitted to the display terminal so as to perform display at the display terminal according to the rendered left-eye viewpoint map and right-eye viewpoint map, the rendered left-eye viewpoint maps and right-eye viewpoint maps may be transmitted to the display terminal, so as to determine, from rendered left-eye viewpoint maps and right-eye viewpoint maps, viewpoint maps at viewpoints corresponding to the human eye positioning coordinate data acquired at the second moment for display according to the human eye positioning coordinate data acquired at the second moment after the first moment. In this way, in addition to rendering a left-eye viewpoint map at a viewpoint corresponding to the horizontal coordinate of the left eye and a right-eye viewpoint map at a viewpoint corresponding to the horizontal coordinate of the right eye, viewpoint maps to which the left eye viewpoints around the viewpoint corresponding to the horizontal coordinate of the left eye and the right eye viewpoints around the viewpoint corresponding to the horizontal coordinate of the right eye correspond are also rendered. This makes these rendered left-eye viewpoint maps and right-eye viewpoint maps include viewpoint maps to which the human eyes of the viewer should correspond at the second moment, so that the display terminal can obtain corresponding viewpoint maps therefrom for display. For example, the display terminal can obtain corresponding viewpoint maps for display by setting a regular moving distance for the time period between the first moment and the second moment based on the moving distance of human eyes or based on experience (such a time period is usually short, so the moving distance is usually a small fixed value), etc., which is not restrictive. The numbers of left-eye viewpoint maps and right-eye viewpoint maps are not limited and not necessarily equal to each other, which may be set based on needs or experience, but are usually small, such as 2 or 3.

In some embodiments, the number N of said portion of left eye viewpoints depends on a moving distance between the horizontal coordinate of the left eye acquired at the second moment and the horizontal coordinate of the left eye acquired at the first moment during the previous frame period. The previous frame period represents a process of determining a viewpoint map at a corresponding viewpoint for display using the previous frame scene image before the current frame scene image. For example, if the moving distance between the horizontal coordinate of the left eye acquired at the second moment and the horizontal coordinate of the left eye acquired at the first moment during the previous frame period is large, it indicates that the human eyes of the viewer move fast, and correspondingly, the number of said portion of left eye viewpoints may be set to be larger. If the moving distance between the horizontal coordinate of the left eye acquired at the second moment and the horizontal coordinate of the left eye acquired at the first moment during the previous frame period is small, it indicates that the human eyes of the viewer move slowly, and correspondingly, the number of said portion of left eye viewpoints may be set to be smaller. Similarly, the number of said other portion of left eye viewpoints may also depend on a moving distance between the horizontal coordinate of the left eye acquired at the second moment and the horizontal coordinate of the left eye acquired at the first moment during the previous frame period. Likewise, the number of said portion of right eye viewpoints and the number of said other portion of right eye viewpoints may depend on a moving distance between the horizontal coordinate of the right eye acquired at the second moment and the horizontal coordinate of the right eye acquired at the first moment during the previous frame period.

In some embodiments, the number of said portion of left eye viewpoints is determined by: determining a moving distance between the horizontal coordinate of the left eye acquired at the second moment and the horizontal coordinate of the left eye acquired at the first moment during the previous frame period; dividing the moving distance by a spacing between adjacent viewpoints of the display presenting the display space to obtain a distance ratio; in response to the distance ratio being an integer, determining the distance ratio as a number of said portion of left eye viewpoints; in response to the distance ratio being not an integer, determining a minimum positive integer larger than the distance ratio as a number of said portion of left eye viewpoints. The number of said portion of left eye viewpoints may be determined, for example, at the display terminal, but of course this is not restrictive. If the current frame is the first frame (there is no previous frame), the number of said portion of left eye viewpoints may be determined as a default value, such as 0 or 1, etc. The number of said other portion of left eye viewpoints, the number of said portion of right eye viewpoints, and the number of said other portion of right eye viewpoints may also be determined in a similar manner, and the description will not be repeated here.

In some embodiments, the number of left-eye viewpoint maps at the multiple left eye viewpoints is equal to the number of right-eye viewpoint maps at the multiple right eye viewpoints, the number of said portion of left eye viewpoints is equal to the number of said other portion of left eye viewpoints, and the number of said portion of right eye viewpoints is equal to the number of said other portion of right eye viewpoints, and wherein said portion of left eye viewpoints and said other portion of left eye viewpoints respectively include viewpoints adjacent to the viewpoint corresponding to the horizontal coordinate of the left eye, and are arranged successively according to the sequence of viewpoints in the display space. Said portion of right eye viewpoints and said other portion of right eye viewpoints respectively include viewpoints adjacent to the viewpoint corresponding to the horizontal coordinate of the right eye, and are arranged successively according to the sequence of viewpoints in the display space. It is assumed that the number of said portion of left eye viewpoints is N. In this case, the acquisition terminal transmits 4N+2 viewpoint maps in total to the display terminal (including a left-eye viewpoint map at the viewpoint corresponding to the horizontal coordinate of the left eye, a right-eye viewpoint map at the viewpoint corresponding to the horizontal coordinate of the right eye). FIG. illustrates an exemplary arrangement of left-eye viewpoint maps, in which the viewpoint corresponding to the horizontal coordinate of the left eye is illustrated as L, the number of said portion of left eye viewpoints is 2, which are illustrated as L1 and L2, and the number of said other portion of left eye viewpoints is also 2, which are illustrated as L3 and L4, wherein, as shown in FIG. 4, L2 and L are adjacent viewpoints of L1 in the display space (“adjacent” means that there are no other viewpoints between them), and L4 and L are adjacent viewpoints of L3. Similarly, the arrangement of the right-eye viewpoint maps is similar to the arrangement of left-eye viewpoint maps, and will not be repeated here.

As an example, the human eye positioning coordinate data at the first moment is obtained during the previous frame period (for example, the horizontal coordinate of the left eye is LX1 and the horizontal coordinate of the right eye is RX1). After the display terminal receives 4N+2 viewpoint maps during the previous frame period, the human eye positioning coordinate data is acquired again at the second moment (for example, the horizontal coordinate of the left eye is LX2 and the horizontal coordinate of the right eye is RX2). Then, S=|LX2˜LX1| is determined for the left eye (the right eye is similar, the value is the same for the right eye in the same row as the value calculated for the left eye), where S is a moving distance between the horizontal coordinate of the left eye acquired at the second moment and the horizontal coordinate of the left eye acquired at the first moment during the previous frame period. If the spacing between adjacent viewpoints of the display is M (this value is related to the optical characteristics of the display, and once the display is determined, this value is a fixed value), S is divided by M to obtain a distance ratio K. If K is an integer, the value of K is determined as the value of N. If the K value is not an integer, a minimum positive integer larger than K is determined as the value of N. The N value determined in this way is a dynamic value, and the N value can be intelligently adjusted in real time according to the moving speed of the human eye. The N value is also calculated and saved during the current frame period, and is transmitted to the acquisition terminal for use in the next frame.

In the video communication method claimed in the present disclosure, the acquisition terminal obtains the human eye positioning coordinate data of the viewer acquired at the display terminal, renders a left-eye viewpoint map at a viewpoint corresponding to the horizontal coordinate of the left eye, and a right-eye viewpoint map at a viewpoint corresponding to the horizontal coordinate of the right eye in the display space based on the current frame scene image of the scene at the acquisition terminal acquired by the acquisition terminal and the human eye positioning coordinates data, and then transmits the rendered left-eye viewpoint map and right-eye viewpoint map to the display terminal so as to perform display at the display terminal according to the rendered left-eye viewpoint map and right-eye viewpoint map. This makes it only necessary to render corresponding viewpoint maps for the left and right eyes at the acquisition terminal and transmit them to the display terminal, so as to perform display at the display terminal according to the rendered left-eye viewpoint map and right-eye viewpoint map. In this way, since only partial viewpoint maps are rendered at the acquisition terminal, the data amount of the rendered viewpoint maps is greatly smaller than the data amount of the scene maps captured by all cameras. Therefore, this technical solution does not require encoding/decoding and transmission of a large amount of data acquired by multiple cameras, thereby reducing needs for hardware such as GPU, decreasing the cost of data transmission (e.g., decreasing the requirements on network bandwidth and server bandwidth), and greatly reducing the power consumption of hardware.

FIG. 6 illustrates a schematic flow chart of a video communication method 600 according to an embodiment of the present disclosure. The method 600 may also be implemented in the architecture of the video communication system described with reference to FIG. 1, and may be applied to the display terminal. The video communication here may be, for example, holographic video communication or the like. The method 600 comprises the following steps.

In step 610, human eye positioning coordinate data of a viewer located at the display terminal is acquired, wherein the human eye positioning coordinate data comprises a horizontal coordinate of the left eye and a horizontal coordinate of the right eye of the viewer in the display space of the display terminal. The display space here may be, for example, a three-dimensional display space. Usually, the viewer views displayed content at the display terminal through a three-dimensional display or display device, so that the viewer is in a virtual display space. As an example, the horizontal direction here is the same as the arrangement direction of viewpoints of the three-dimensional display or display device, i.e., being the same as the horizontal direction or the lateral direction of the three-dimensional display or display device.

As an example, FIG. 7 illustrates an exemplary method 700 for acquiring human eye positioning coordinate data at the display terminal. As shown in FIG. 7, in step 710, a human eye image including the left eye and the right eye of the viewer in the display space of the display terminal is obtained. In some embodiments, the human eye image may be captured using a camera located in a middle region of the display space at the display terminal. Then, in step 720, a region of interest including the left eye is detected in the human eye image to obtain a left-eye region image, and a region of interest including the right eye is detected to obtain a right-eye region image. At 730, the left-eye region image and the right-eye region image are denoised to obtain a left-eye denoised image and a right-eye denoised image. In step 740, a gradient calculation is performed on the left-eye denoised image and the right-eye denoised image respectively, and the horizontal coordinate of a point with a largest number of straight line intersections in the gradient direction in a respective denoised image of the left-eye denoised image and the right-eye denoised image is determined as the horizontal coordinate of an eye of the viewer in a respective direction. That is, the horizontal coordinate of a point with a largest number of straight line intersections in the gradient direction in the left-eye denoised image and the right-eye denoised image is determined as the horizontal coordinate of the left eye of the viewer, and the horizontal coordinate of a point with a largest number of straight line intersections in the gradient direction in the right-eye denoised image is determined as the horizontal coordinate of the right eye of the viewer. Usually, gradient includes amplitude and direction. For an eye image, the position closer to the eyeball center will have a lower gray value, and there will be more connection lines in the gradient direction intersecting at that point. Therefore, the determination of the human eye center position (i.e., human eye positioning data) is to find a point with a largest number of straight line intersections in the gradient direction. With this method, human eye positioning coordinate data can be accurately acquired.

In step 620, the human eye positioning coordinate data is transmitted to the acquisition terminal. The human eye positioning coordinate data is transmitted to the acquisition terminal, so that the acquisition terminal can render multiple left-eye viewpoint maps and multiple right-eye viewpoint maps according to the human eye positioning coordinate data, which is similar to the embodiment described with reference to FIG. 3.

In step 630, left-eye viewpoint maps and right-eye viewpoint maps are obtained. The left-eye viewpoint maps include a left-eye viewpoint map at a viewpoint corresponding to the horizontal coordinate of the left eye in the display space which is rendered by the acquisition terminal according to the current frame scene image acquired by the acquisition terminal and the human eye positioning coordinate data, and the right-eye viewpoint maps include a right-eye viewpoint map at a viewpoint corresponding to the horizontal coordinate of the right eye in the display space which is rendered by the acquisition terminal according to the current frame scene image acquired by the acquisition terminal and the human eye positioning coordinate data.

In some embodiments, the current frame scene image acquired by the acquisition terminal includes current frame color images of the scene and current frame depth images of the scene acquired at multiple different viewing angles of the acquisition terminal. “Multiple” here may refer to two or more. The current frame refers to a scene image that matches the human eye positioning coordinate data received by the acquisition terminal most recently.

The acquisition terminal may employ various methods to render a left-eye viewpoint map at a viewpoint corresponding to the horizontal coordinate of the left eye and a right-eye viewpoint map at a viewpoint corresponding to the horizontal coordinate of the right eye in the display space. For example, it is possible to first perform space reconstruction (for example, three-dimensional space reconstruction) according to the current frame scene image to obtain an overall spatial map of the display space, and then render a left-eye viewpoint map at a viewpoint corresponding to the horizontal coordinate of the left eye and a right-eye viewpoint map at a viewpoint corresponding to the horizontal coordinate of the right eye in the display space according to the human eye positioning coordinate data. For another example, frame interpolation may be performed on the current frame scene image according to the human eye positioning coordinate data, thereby rendering a left-eye viewpoint map at a viewpoint corresponding to the horizontal coordinate of the left eye and a right-eye viewpoint map at a viewpoint corresponding to the horizontal coordinate of the right eye in the display space.

In some embodiments, a deep learning network may also be used for rendering, that is, the current frame scene image and the human eye positioning coordinate data are inputted into a trained viewpoint map generation model to obtain a left-eye viewpoint map at a viewpoint corresponding to the horizontal coordinate of the left eye and a right-eye viewpoint map at a viewpoint corresponding to the horizontal coordinate of the right eye in the display space. The trained viewpoint map generation model is trained in any appropriate manner, such as the training manners described in the embodiment of FIG. 3.

In step 640, display is performed based on the obtained left-eye viewpoint maps and right-eye viewpoint maps.

In some embodiments, when the display terminal obtains the left-eye viewpoint map and the right-eye viewpoint map, the human eye positions may have changed and are no longer located at the original horizontal coordinates, which results in changes in the viewing angles of the human eyes. For example, the human eye positioning coordinate data of the viewer is acquired at the display terminal at a first moment, and after the display terminal obtains the left-eye viewpoint map and the right-eye viewpoint map, the human eye positioning coordinates of the viewer are acquired again at a second moment so as to determine whether the human eye positions have changed. In order to be able to cope with the situation where changes have occurred, the left-eye viewpoint maps rendered by the acquisition terminal may further include left-eye viewpoint maps at multiple left eye viewpoints, and the rendered right-eye viewpoint maps may further include right-eye viewpoint maps at multiple right eye viewpoints; wherein the horizontal coordinates to which a portion of left eye viewpoints of the multiple left eye viewpoints correspond are smaller than the horizontal coordinate of the left eye, and the horizontal coordinates to which the other portion of left eye viewpoints correspond are greater than the horizontal coordinate of the left eye, and wherein the horizontal coordinates to which a portion of right eye viewpoints of the multiple right eye viewpoints correspond are smaller than the horizontal coordinate of the right eye, and the horizontal coordinates to which the other portion of right eye viewpoints correspond are greater than the horizontal coordinate of the right eye. In this case, when performing display at the display terminal according to the obtained left-eye viewpoint maps and right-eye viewpoint maps, it is possible to determine, from rendered left-eye viewpoint maps and right-eye viewpoint maps, viewpoint maps at viewpoints corresponding to the human eye positioning coordinate data acquired at the second moment for display according to the human eye positioning coordinate data acquired at the second moment after the first moment. In other words, in addition to rendering a left-eye viewpoint map at a viewpoint corresponding to the horizontal coordinate of the left eye and a right-eye viewpoint map at a viewpoint corresponding to the horizontal coordinate of the right eye, the acquisition terminal also renders viewpoint maps to which the left eye viewpoints around the viewpoint corresponding to the horizontal coordinate of the left eye and the right eye viewpoints around the viewpoint corresponding to the horizontal coordinate of the right eye correspond. The display terminal can obtain corresponding viewpoint maps for display by setting a regular moving distance for the time period between the first moment and the second moment based on the moving distance of the human eyes or based on experience (such a time period is usually short, so the moving distance is usually a small fixed value), etc., which is not restrictive. The numbers of left-eye viewpoint maps and right-eye viewpoint maps are not limited and not necessarily equal to each other, which may be set based on needs or experience, but are usually small, such as 2 or 3. In some embodiments, at the time of determining, based on human eye positioning coordinate data acquired at a second moment after the first moment, viewpoint maps at viewpoints corresponding to the human eye positioning coordinate data acquired at the second moment from rendered left-eye viewpoint maps and right-eye viewpoint maps for display, it is possible to determine a first horizontal coordinate closest to the horizontal coordinate of the left eye acquired at the second moment from the horizontal coordinates to which the rendered left-eye viewpoint maps correspond, and to determine a second horizontal coordinate closest to the horizontal coordinate of the right eye acquired at the second moment from the horizontal coordinates to which the rendered right-eye viewpoint maps correspond. Then, a left-eye viewpoint map to which the first horizontal coordinate corresponds and a right-eye viewpoint map to which the second horizontal coordinate corresponds are displayed. During display, pixels can be rearranged based on the optical display characteristics of the display so as to obtain and display image data that the display needs to display, which will be described in detail below.

In some embodiments, the number N of said portion of left eye viewpoints depends on a moving distance between the horizontal coordinate of the left eye acquired at the second moment and the horizontal coordinate of the left eye acquired at the first moment during the previous frame period. The previous frame period represents a process of determining a viewpoint map at a corresponding viewpoint for display using the previous frame scene image before the current frame scene image. For example, if the moving distance between the horizontal coordinate of the left eye acquired at the second moment and the horizontal coordinate of the left eye acquired at the first moment during the previous frame period is large, it indicates that the human eyes of the viewer move fast, and correspondingly, the number of said portion of left eye viewpoints may be set to be larger. If the moving distance between the horizontal coordinate of the left eye acquired at the second moment and the horizontal coordinate of the left eye acquired at the first moment during the previous frame period is small, it indicates that the human eyes of the viewer move slowly, and correspondingly, the number of said portion of left eye viewpoints may be set to be smaller. Similarly, the number of said other portion of left eye viewpoints may also depend on a moving distance between the horizontal coordinate of the left eye acquired at the second moment and the horizontal coordinate of the left eye acquired at the first moment during the previous frame period. Likewise, the number of said portion of right eye viewpoints and the number of said other portion of right eye viewpoints may depend on a moving distance between the horizontal coordinate of the right eye acquired at the second moment and the horizontal coordinate of the right eye acquired at the first moment during the previous frame period.

In some embodiments, the number of said portion of left eye viewpoints can be determined by: determining a moving distance between the horizontal coordinate of the left eye acquired at the second moment and the horizontal coordinate of the left eye acquired at the first moment during the previous frame period; dividing the moving distance by a spacing between adjacent viewpoints of the display presenting the display space to obtain a distance ratio; in response to the distance ratio being an integer, determining the distance ratio as a number of said portion of left eye viewpoints; in response to the distance ratio being not an integer, determining a minimum positive integer larger than the distance ratio as a number of said portion of left eye viewpoints. The number of said portion of left eye viewpoints may be determined, for example, at the display terminal, but of course this is not restrictive. If the current frame is the first frame (there is no previous frame), the number of said portion of left eye viewpoints may be determined as a default value, such as 0 or 1, etc. The number of said other portion of left eye viewpoints, the number of said portion of right eye viewpoints, and the number of said other portion of right eye viewpoints may also be determined in a similar manner, which will not be repeated here.

In some embodiments, the number of left-eye viewpoint maps at the multiple left eye viewpoints is equal to the number of right-eye viewpoint maps at the multiple right eye viewpoints, the number of said portion of left eye viewpoints is equal to the number of said other portion of left eye viewpoints, and the number of said portion of right eye viewpoints is equal to the number of said other portion of right eye viewpoints, and wherein said portion of left eye viewpoints and said other portion of left eye viewpoints respectively include viewpoints adjacent to the viewpoint corresponding to the horizontal coordinate of the left eye, and are arranged successively according to the sequence of viewpoints in the display space. Said portion of right eye viewpoints and said other portion of right eye viewpoints respectively include viewpoints adjacent to the viewpoint corresponding to the horizontal coordinate of the right eye, and are arranged successively according to the sequence of viewpoints in the display space. It is assumed that the number of said portion of left eye viewpoints is N. In this case, the display terminal obtains 4N+2 viewpoint maps in total (including a left-eye viewpoint map at the viewpoint corresponding to the horizontal coordinate of the left eye, a right-eye viewpoint map at the viewpoint corresponding to the horizontal coordinate of the right eye).

As an example, the human eye positioning coordinate data at the first moment is obtained during the previous frame period (for example, the horizontal coordinate of the left eye is LX1 and the horizontal coordinate of the right eye is RX1). After the display terminal receives 4N+2 viewpoint maps during the previous frame period, the human eye positioning coordinate data is acquired again at the second moment (for example, the horizontal coordinate of the left eye is LX2 and the horizontal coordinate of the right eye is RX2). Then, S=|LX2˜LX1| is determined for the left eye (the right eye is similar, the value is the same for the right eye in the same row as the value calculated for the left eye), where S is a moving distance between the horizontal coordinate of the left eye acquired at the second moment and the horizontal coordinate of the left eye acquired at the first moment during the previous frame period. If the spacing between adjacent viewpoints of the display (e.g., 3D display) is M (this value is related to the optical characteristics of the display, and once the display is determined, this value is a fixed value), S is divided by M to obtain a distance ratio K. If K is an integer, the value of K is determined as the value of N. If the K value is not an integer, a minimum positive integer larger than K is determined as the value of N. The N value determined in this way is a dynamic value, and the N value can be intelligently adjusted in real time according to the moving speed of the human eye. The N value is also calculated and saved during the current frame period, and is transmitted to the acquisition terminal for use in the next frame.

These viewpoint maps obtained by the display terminal have a corresponding horizontal coordinate in the display space, respectively. In some embodiments, at the time of determining, based on human eye positioning coordinate data acquired at a second moment after the first moment, viewpoint maps at viewpoints corresponding to the human eye positioning coordinate data acquired at the second moment from rendered left-eye viewpoint maps and right-eye viewpoint maps for display, it is possible to determine a first horizontal coordinate closest to the horizontal coordinate of the left eye acquired at the second moment from the horizontal coordinates to which the rendered left-eye viewpoint maps correspond, and to determine a second horizontal coordinate closest to the horizontal coordinate of the right eye acquired at the second moment from the horizontal coordinates to which the rendered right-eye viewpoint maps correspond. Then, a left-eye viewpoint map to which the first horizontal coordinate corresponds, a right-eye viewpoint map to which the second horizontal coordinate corresponds, and viewpoint maps at viewpoints corresponding to the human eye positioning coordinate data acquired at the second moment are displayed. During display, pixels can be rearranged based on the optical display characteristics of the display so as to obtain and display image data that the display needs to display. As an example, coordinates closest to LX2 and RX2 are found from the horizontal coordinates to which the aforementioned 4N+2 viewpoint maps correspond, and the viewpoint maps to which the coordinates correspond are viewpoint maps that needs to be displayed. Then, pixels are rearranged based on the optical display characteristics of the display so as to obtain and display image data that the display needs to display.

In some embodiments, when pixels are being rearranged, the position of a sub-pixel in the display screen corresponding to the viewpoint where the viewpoint map (the viewpoint map is one of the left-eye viewpoint map and the right-eye viewpoint map described above) is located is first determined, and a sub-pixel corresponding to the viewpoint map is then arranged at the position of the sub-pixel of the display screen for display.

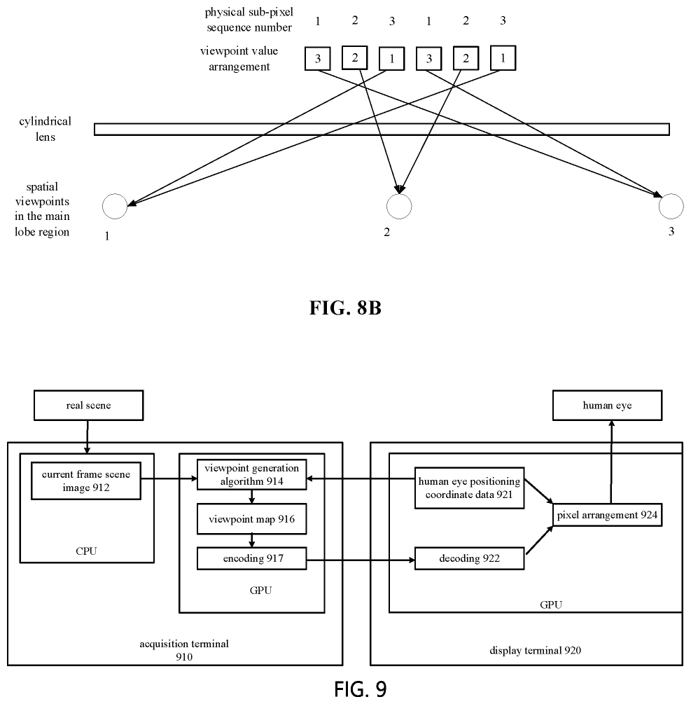

As an example, general naked-eye 3D displays mostly use a cylindrical lens array principle. Here, detailed description will be provided based on an example in which an optical cylindrical lens array is arranged vertically and attached to the screen. It is assumed that a cylindrical lens covers 16 sub-pixels (screen sub-pixels) of the screen laterally, as shown in FIG. 8A. The physical sub-pixel sequence number mark the actual sub-pixel positions of the screen, which are 1 to 16 sub-pixels from left to right. The viewpoint value arrangement indicates which sub-pixels 16 images taken in a virtual scene should be filled into. A certain sub-pixel value of the 16-th image in FIG. 8A is filled into a sub-pixel of the screen with a physical sub-pixel sequence number 1. After passing through the cylindrical lens, said sub-pixel can be seen by human eyes at the position of the spatial viewpoint 16 in the main lobe region. Therefore, when pixels are being rearranged, a sub-pixel in the viewpoint map at the viewpoint 16 should be arranged at the position of the physical sub-pixel sequence number 1 for display. FIG. 8A only illustrates a pixel arrangement viewpoint map within a single period (i.e., a single viewpoint sub-pixel). However, one viewpoint map includes multiple sub-pixels, and FIG. 8B illustrates a schematic view in this case, i.e., a schematic view of multi-period pixel arrangement. As shown in FIG. 8B, the sub-pixel 3 of the viewpoint map corresponding to the viewpoint 3 is sequentially arranged at the position of the physical sub-pixel sequence number 1 for display, the sub-pixel 2 of the viewpoint map corresponding to the viewpoint 2 is sequentially arranged at the position of the physical sub-pixel sequence number 2 for display, and the sub-pixel 1 of the viewpoint map corresponding to the viewpoint 1 is sequentially arranged at the position of the physical sub-pixel sequence number 3 for display.

In the video communication method claimed in the present disclosure, the display terminal transmits the acquired human eye positioning coordinate data of the viewer to the acquisition terminal, and obtains left-eye viewpoint maps and right-eye viewpoint maps from the acquisition terminal, wherein the left-eye viewpoint maps includes a left-eye viewpoint map at a viewpoint corresponding to the horizontal coordinate of the left eye in the display space which is rendered by the acquisition terminal according to the current frame scene image acquired by the acquisition terminal and the human eye positioning coordinate data, and the right-eye viewpoint maps includes a right-eye viewpoint map at a viewpoint corresponding to the horizontal coordinate of the right eye in the display space which is rendered by the acquisition terminal according to the current frame scene image acquired by the acquisition terminal and the human eye positioning coordinate data, and then performs display according to the obtained left-eye viewpoint maps and right-eye viewpoint maps. This eliminates the need for the display terminal to render a large number of viewpoint maps. It is only required to transmit the acquired human eye positioning coordinate data of the viewer to the acquisition terminal, and render corresponding viewpoint maps for left and right eyes at the acquisition terminal and transmit them to the display terminal, so as to perform display at the display terminal according the rendered left-eye viewpoint map and right-eye viewpoint map. In this way, since only partial viewpoint maps are rendered at the acquisition terminal, the data amount of the rendered viewpoint maps is greatly smaller than the data amount of the scene maps captured by all cameras. Therefore, this technical solution does not require encoding/decoding and transmission of a large amount of data acquired by multiple cameras, thereby reducing needs for hardware such as GPU, decreasing the cost of data transmission (e.g., decreasing the requirements on network bandwidth and server bandwidth), and greatly reducing the power consumption of hardware.

It is to be noted that the embodiment described with reference to FIG. 3 and the embodiment described with reference to FIG. 6 may be used together. As an example, FIG. 9 illustrates a schematic flow chart of a video communication method according to an embodiment of the present disclosure.

As shown in FIG. 9, after human eye positioning coordinate data 921 of a viewer located at the display terminal is acquired, a display terminal 920 transmits it to an acquisition terminal 910. After or while obtaining the human eye positioning coordinate data of the viewer acquired at the display terminal, the acquisition terminal 910 acquires a current frame scene image 912 of a scene located at the acquisition terminal and transmits it to the CPU. The CPU then transmits the current frame scene image 912 to the GPU. Then, the GPU of the acquisition terminal uses, for example, various viewpoint generation algorithms 914 to render a left-eye viewpoint map at a viewpoint corresponding to the horizontal coordinate of the left eye and a right-eye viewpoint map at a viewpoint corresponding to the horizontal coordinate of the right eye in the display space according to the current frame scene image and the human eye positioning coordinate data, such as viewpoint maps 916 in the figure. Thereafter, the viewpoint maps 916 are encoded 917 to obtain encoded data. The acquisition terminal transmits the encoded data to the display terminal 920 via a network, for example. After the display terminal obtains the encoded data, it uses the GPU to decode 922 the encoded data to obtain the viewpoint maps 916. Then, pixel arrangement 924 is performed again based on the optical display characteristics of the 3D display so as to obtain and display image data that the display needs to display.

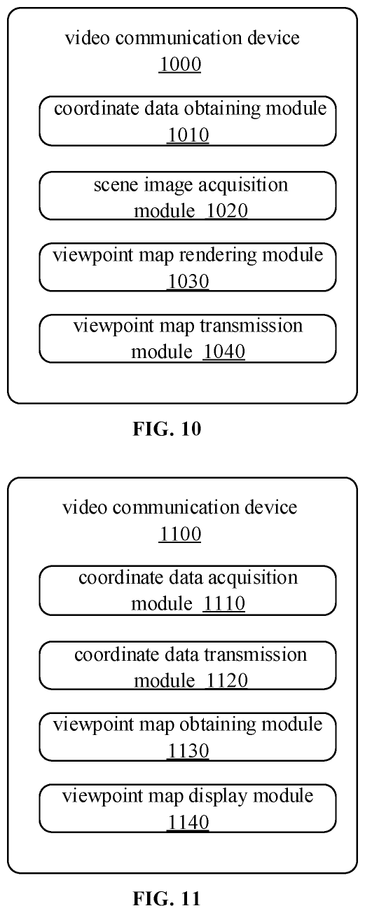

FIG. 10 illustrates an exemplary structural block diagram of a video communication device 1000 according to an embodiment of the present disclosure, which is applied to an acquisition terminal. As shown in FIG. 10, the video communication device 1000 comprises a coordinate data obtaining module 1010, a scene image acquisition module 1020, a viewpoint map rendering module 1100, and a viewpoint map transmission module 1040.

The coordinate data obtaining module 1010 is configured to obtain human eye positioning coordinate data of a viewer acquired at the display terminal, wherein the human eye positioning coordinate data includes a horizontal coordinate of the left eye and a horizontal coordinate of the right eye of the viewer in the display space of the display terminal. The scene image acquisition module 1020 is configured to acquire a current frame scene image of a scene located at the acquisition terminal. The viewpoint map rendering module 1030 is configured to render, according to the current frame scene image and the human eye positioning coordinate data, a left-eye viewpoint map at a viewpoint corresponding to the horizontal coordinate of the left eye and a right-eye viewpoint map at a viewpoint corresponding to the horizontal coordinate of the right eye in the display space. The viewpoint map transmission module 1040 is configured to transmit the rendered left-eye viewpoint map and right-eye viewpoint map to the display terminal, so as to perform display at the display terminal according to the rendered left-eye viewpoint map and right-eye viewpoint map.

The video communication device 1000 has the same high technical effect as the method described with reference to FIG. 3, which will not be repeated here.

FIG. 11 illustrates an exemplary structural block diagram of a video communication device 1100 according to an embodiment of the present disclosure, which is applied to a display terminal. As shown in FIG. 11, the video communication device 1100 comprises a coordinate data acquisition module 1110, a coordinate data transmission module 1120, a viewpoint map obtaining module 1130, and a viewpoint map display module 1140.

The coordinate data acquisition module 1110 is configured to acquire human eye positioning coordinate data of a viewer located at the display terminal, wherein the human eye positioning coordinate data includes a horizontal coordinate of the left eye and a horizontal coordinate of the right eye of the viewer in the display space of the display terminal. The coordinate data transmission module 1120 is configured to transmit the human eye positioning coordinate data to an acquisition terminal. The viewpoint map obtaining module 1130 is configured to obtain a left-eye viewpoint map and a right-eye viewpoint map. The left-eye viewpoint map includes a left-eye viewpoint map at a viewpoint corresponding to the horizontal coordinate of the left eye in the display space which is rendered by the acquisition terminal according to the current frame scene image acquired by the acquisition terminal and the human eye positioning coordinate data, and the right-eye viewpoint map includes a right-eye viewpoint map at a viewpoint corresponding to the horizontal coordinate of the right eye in the display space which is rendered by the acquisition terminal according to the current frame scene image acquired by the acquisition terminal and the human eye positioning coordinate data. The viewpoint map display module 1140 is configured to perform display according to the obtained left-eye viewpoint maps and right-eye viewpoint maps.

The video communication device 1100 has the same high technical effect as the method described with reference to FIG. 6, which will not be repeated here.

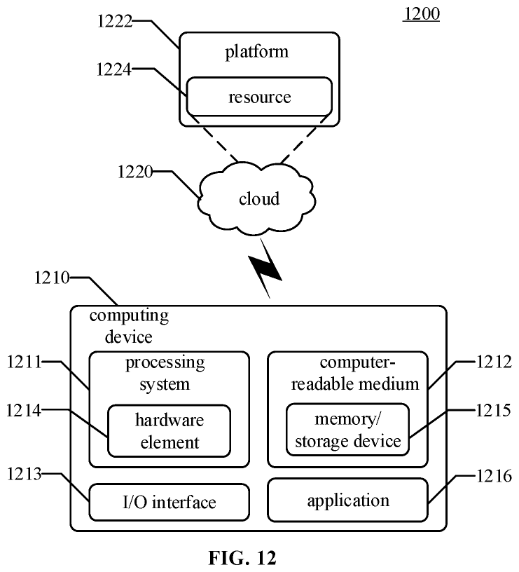

FIG. 12 illustrates an exemplary system 1200 comprising an exemplary computing device 1210 representative of one or more systems and/or devices that may implement various techniques described herein. The computing device 1210 may be, for example, a server of a service provider, a device associated with a server, a system on a chip, and/or any other suitable computing device or computing system.

The exemplary computing device 1210 as illustrated comprises a processing system 1211, one or more computer-readable media 1212, and one or more I/O interfaces 1213 communicatively coupled with each other. Although not shown, the computing device 1210 may also comprise a system bus or other data and command transmission systems that couple various components to one another. The system bus may include any one or a combination of different bus structures, such as a memory bus or memory controller, a peripheral bus, a universal serial bus, and/or a processor utilizing any one of the various bus architectures, or a local bus. Various other examples are also contemplated, such as control and data lines.

The processing system 1211 represents functionality of using hardware to perform one or more operations. Accordingly, the processing system 1211 is illustrated as including a hardware element 1214 that may be configured as a processor, a functional block, and the like. This may include implementation in hardware as an application specific integrated circuit or other logic devices formed using one or more semiconductors. The hardware element 1214 is not limited by the material from which it is formed or the processing mechanisms employed therein. For example, a processor may be composed of semiconductor(s) and/or transistors (e.g., electronic integrated circuits (ICs)). In such context, processor-executable instructions may be electronically executable instructions.

The computer-readable medium 1212 is illustrated as including a memory/storage device 1215. The memory/storage device 1215 represents a memory/storage capacity associated with one or more computer-readable media. The memory/storage device 1215 may include a volatile medium (such as a random access memory (RAM)) and/or a non-volatile medium (such as a read-only memory (ROM), a flash memory, an optical disk, a magnetic disk, etc.). The memory/storage device 1215 may include a fixed medium (e.g., an RAM, an ROM, a fixed hard disc driver, etc.) as well as a removable medium (e.g., a flash memory, a removable hard disc driver, an optical disk, etc.). The computer-readable medium 1212 may be configured in various other ways further described below.

One or more I/O interfaces 1213 represent functionality of allowing a user to input commands and information to the computing device 1210 using various input devices and optionally further allowing information to be presented to the user and/or other components or devices using various output devices. Examples of input devices include keyboards, cursor control devices (e.g., mice), microphones (e.g., for voice input), scanners, touch function (e.g., configured as capacitive or other sensors for detecting physical touch), cameras (for example, motions that do not involve touch can be detected as gestures using visible or invisible wavelengths (such as infrared frequency), and so on. Examples of output devices include display devices (e.g., monitors or projectors), loudspeakers, printers, network cards, tactile-responsive devices, and so on. Accordingly, the computing device 1210 may be configured in various manners further described below so as to support user interaction.

The computing device 1210 further comprises an application 1216. The application 1216 may be, for example, a software instance of a video communications device 1000 or 1100 and, in combination with other elements in the computing device 1210, implement the techniques described herein.

Various techniques may be described herein in the general context of software, hardware elements, or program modules. Generally, these modules include routines, programs, objects, elements, components, data structures, etc. that perform specific tasks or implement specific abstract data types. As used herein, the terms “module”, “function” and “component” generally denote software, firmware, hardware, or a combination thereof. The techniques described herein are characterized by being platform-independent, which means that these techniques can be implemented on a variety of computing platforms with a variety of processors.

Implementations of the described modules and techniques may be stored in or transmitted across computer-readable media in certain forms. The computer-readable media may include a variety of media that can be accessed by the computing device 1210. By way of example, and not limitation, the computer-readable media may include “computer-readable storage media” and “computer-readable signal media”.

As opposed to mere signal transmission, a carrier wave or a signal itself, the “computer-readable storage medium” refers to a medium and/or device capable of storing information persistently, and/or a tangible storage device. Therefore, computer-readable storage media refers to non-signal carrying media. Computer-readable storage media include, for example, volatile and nonvolatile, removable and non-removable media and/or hardware such as storage devices implemented with methods or techniques suitable for information storage (such as computer-readable instructions, data structures, program modules, logic elements/circuits or other data). Examples of computer-readable storage media may include, but are not limited to, an RAM, an ROM, an EEPROM, a flash memory or other memory technology, a CD-ROM, a digital versatile disk (DVD) or other optical storage devices, a hard drive, a cassette, a magnetic tape, a magnetic disk storage device or other magnetic storage devices, or other storage devices, a tangible medium, or a product suitable for storing the desired information and accessible by a computer.

The “computer-readable signal medium” refers to a signal carrying medium configured as hardware to transmit instructions to the computing device 1210, such as via a network. Signal media may typically embody computer readable instructions, data structures, program modules or other data in modulated data signals such as a carrier wave, a data signal, or other transmission mechanisms. Signal media further include any information delivery medium. The term “modulated data signal” refers to a signal in which one or more of the characteristics of the signal are set or changed to encode information into the signal. By way of example, and not limitation, communication media include wired media, such as a wired network or direct wiring, and wireless media, such as acoustic, RF, infrared, and other wireless media.

As described previously, hardware elements 1214 and computer-readable media 1212 represent instructions, modules, programmable device logics, and/or fixed device logics implemented in hardware that, in some embodiments, may be used to implement at least some aspects of the techniques described herein. Hardware elements may include an integrated circuit or system on a chip, an application specific integrated circuit (ASIC), a field programmable gate array (FPGA), a complex programmable logic devices (CPLD), and other implementations in silicon or components of other hardware devices. In such a context, a hardware element may serve as a processing device for performing program tasks defined by the instructions, modules, and/or logics embodied by the hardware element, as well as a hardware device for storing instructions for execution, e.g., a computer-readable storage medium previously described.

Combinations of the foregoing may also be used to implement the various techniques and modules described herein. Therefore, software, hardware, or program modules and other program modules may be implemented as one or more instructions and/or logics embodied on computer-readable storage medium in certain forms and/or embodied by one or more hardware elements 1214. The computing device 1210 may be configured to implement specific instructions and/or functions corresponding to software and/or hardware modules. Thus, modules may be implemented, at least in part, in hardware, as modules executable by the computing device 1210 as software, for example, using computer-readable storage media and/or hardware elements 1214 of the processing system. Instructions and/or functions may be executable/operable by one or more products (for example, one or more computing devices 1210 and/or processing systems 1211) so as to implement the techniques, modules, and examples described herein.

In various implementations, the computing device 1210 may employ a variety of different configurations. For example, the computing device 1210 may be implemented as a computer-type device including a personal computer, a desktop computer, a multi-screen computer, a laptop computer, a netbook, and the like. The computing device 1210 may also be implemented as a mobile device-type device including a mobile device such as a mobile phone, a portable music player, a portable gaming device, a tablet computer, a multi-screen computer, and the like. The computing device 1210 may also be implemented as a television-type device, which includes a device having or being connected to a generally larger screen in a casual viewing environment. These devices include televisions, set-top boxes, game consoles, and the like.

The techniques described herein may be supported by these various configurations of the computing device 1210 and are not limited to specific examples of the techniques described herein. Functionality may also be implemented in whole or in part on a “cloud” 1220 by using a distributed system, such as through a platform 1222 described below.

The cloud 1220 includes and/or represents a platform 1222 for resources 1224. The platform 1222 abstracts the underlying functionality of the hardware (e.g., server) and software resources of the cloud 1220. The resources 1224 may include applications and/or data that may be used while performing computer processing on a server remote from the computing device 1210. The resources 1224 may also include services provided over the Internet and/or through subscriber networks such as cellular or Wi-Fi networks.

The platform 1222 can abstract resources and functionality to connect the computing device 1210 with other computing devices. The platform 1222 may also be used to abstract the hierarchy of resources to provide a corresponding level of hierarchy of requirements encountered for resources 1224 implemented via the platform 1222. Accordingly, in an interconnected device embodiment, implementation of the functionality described herein may be distributed throughout the system 1200. For example, functionality may be implemented in part on the computing device 1210 and through the platform 1222 that abstracts the functionality of the cloud 1220.

The present disclosure provides a computer-readable storage medium in which computer-readable instructions are stored. When executed, the computer-readable instructions implement any one of the methods described above.

The present disclosure provides a computer program product or computer program that includes computer instructions stored in a computer-readable storage medium. The processor of the computing device reads the computer instructions from the computer-readable storage medium, and the processor executes the computer instructions, so that the computing device performs any of the methods provided in the above various optional implementations.

It should be understood that, for clarity, embodiments of the present disclosure have been described with reference to different functional units. However, it will be apparent that the functionality of each functional unit may be implemented in a single unit, in a plurality of units or as part of other functional units without departing from the present disclosure. For example, functionality described as being performed by a single unit may be performed by multiple different units. Therefore, references to specific functional units are merely to be considered as references to appropriate units for providing the described functionality and are not intended to indicate strict logical or physical structures or organizations. Thus, the present disclosure may be implemented in a single unit, or may be physically and functionally distributed between different units and circuits.

It will be understood that, although the terms such as first, second and third may be used herein to describe various devices, elements, components or sections, these devices, elements, components or sections should not be limited by these terms. These terms are only used to distinguish one device, element, component or section from another device, element, component or section.

Although the present disclosure has been described in connection with some embodiments, it is not intended to be limited to the specific forms set forth herein. On the contrary, the scope of the present disclosure is limited only by the appended claims. Additionally, although individual features may be included in different claims, these features may possibly be advantageously combined, and the inclusion in different claims does not imply that a combination of features is not feasible and/or advantageous. The order of features in the claims does not imply any specific order in which the features must be operated. Furthermore, in the claims, the word “comprising” does not exclude other elements and the term “a” or “an” does not exclude a plurality. Reference signs in the claims are provided merely as clear examples and shall not be construed as limiting the scope of the claims in any way.

1. A video communication method applied to an acquisition terminal, comprising:
obtaining human eye positioning coordinate data of a viewer acquired at a display terminal, wherein the human eye positioning coordinate data comprises a horizontal coordinate of a left eye and a horizontal coordinate of a right eye of the viewer in a display space of the display terminal;
acquiring a current frame scene image of a scene located at the acquisition terminal;
rendering a left-eye viewpoint map at a viewpoint corresponding to the horizontal coordinate of the left eye and a right-eye viewpoint map at a viewpoint corresponding to the horizontal coordinate of the right eye in the display space according to the current frame scene image and the human eye positioning coordinate data; and
transmitting rendered left-eye viewpoint map and right-eye viewpoint map to the display terminal, so as to perform display at the display terminal according to the rendered left-eye viewpoint map and right-eye viewpoint map.

2. The method according to claim 1, wherein said acquiring a current frame scene image of a scene located at the acquisition terminal comprises:
acquiring current frame color images of the scene and current frame depth images of the scene at multiple different viewing angles of the acquisition terminal.

3. The method according to claim 1, wherein the human eye positioning coordinate data of the viewer is acquired by performing operations comprising:
obtaining a human eye image comprising the left eye and the right eye of the viewer in the display space of the display terminal;
detecting, in the human eye image, regions of interest comprising the left eye and the right eye respectively to obtain a left-eye region image and a right-eye region image;
denoising the left-eye region image and the right-eye region image to obtain a left-eye denoised image and a right-eye denoised image; and
performing a gradient calculation on the left-eye denoised image and the right-eye denoised image, respectively, and determining a horizontal coordinate of a point with a largest number of straight line intersections in a gradient direction in a respective denoised image of the left-eye denoised image and the right-eye denoised image as a horizontal coordinate of an eye of the viewer in a respective direction.

4. The method according to claim 1, wherein said rendering a left-eye viewpoint map at a viewpoint corresponding to the horizontal coordinate of the left eye and a right-eye viewpoint map at a viewpoint corresponding to the horizontal coordinate of the right eye in the display space according to the current frame scene image and the human eye positioning coordinate data comprises:
inputting the current frame scene image and the human eye positioning coordinate data into a trained viewpoint map generation model to obtain a left-eye viewpoint map at a viewpoint corresponding to the horizontal coordinate of the left eye and a right-eye viewpoint map at a viewpoint corresponding to the horizontal coordinate of the right eye in the display space,
wherein the trained viewpoint map generation model is obtained by performing operations comprising:
obtaining a training set, the training set comprising a plurality of sample groups, each sample group comprising a sample scene image, a horizontal coordinate of a sample human eye, and a corresponding target viewpoint map at a viewpoint corresponding to the horizontal coordinate of the sample human eye in the display space;
inputting the sample scene image and the horizontal coordinate of the sample human eye in each sample group into an initial viewpoint map generation model to obtain a corresponding predicted viewpoint map at a viewpoint corresponding to the horizontal coordinate of the sample human eye in the display space; and
adjusting the initial viewpoint map generation model to minimize an error between a target viewpoint map and a predicted viewpoint map corresponding to each sample group, thereby obtaining the trained viewpoint map generation model.

5. The method according to claim 1, wherein the human eye positioning coordinate data of the viewer is acquired at the display terminal at a first moment, and the method further comprises:
according to the current frame scene image, horizontal coordinates corresponding to multiple left eye viewpoints and horizontal coordinates corresponding to multiple right eye viewpoints, rendering left-eye viewpoint maps at the multiple left eye viewpoints and right-eye viewpoint maps at the multiple right eye viewpoints in the display space,
wherein horizontal coordinates to which a portion of left eye viewpoints of the multiple left eye viewpoints correspond are smaller than the horizontal coordinate of the left eye, and horizontal coordinates to which the other portion of left eye viewpoints correspond are larger than the horizontal coordinate of the left eye,
wherein horizontal coordinates to which a portion of right eye viewpoints of the multiple right eye viewpoints correspond are smaller than the horizontal coordinate of the right eye, and horizontal coordinates to which the other portion of right eye viewpoints correspond are larger than the horizontal coordinate of the right eye, and
wherein said transmitting rendered left-eye viewpoint map and right-eye viewpoint map to the display terminal, so as to perform display at the display terminal according to the rendered left-eye viewpoint map and right-eye viewpoint map comprises:
transmitting the rendered left-eye viewpoint maps and right-eye viewpoint maps to the display terminal, so as to determine, based on human eye positioning coordinate data acquired at a second moment after the first moment, viewpoint map at viewpoints corresponding to the human eye positioning coordinate data acquired at the second moment from the rendered left-eye viewpoint maps and right-eye viewpoint maps for display.

6. The method according to claim 5, wherein a number of said portion of left eye viewpoints depends on a moving distance between a horizontal coordinate of the left eye acquired at the second moment and a horizontal coordinate of the left eye acquired at the first moment during a previous frame period, the previous frame period represents a process of determining a viewpoint map at a corresponding viewpoint for display using a previous frame scene image before the current frame scene image.

7. The method according to claim 6, wherein the number of said portion of left eye viewpoints is determined by performing operations comprising:
determining a moving distance between a horizontal coordinate of the left eye acquired at the second moment and a horizontal coordinate of the left eye acquired at the first moment during a previous frame period;
dividing the moving distance by a spacing between adjacent viewpoints of a display presenting the display space to obtain a distance ratio;
in response to the distance ratio being an integer, determining the distance ratio as the number of said portion of left eye viewpoints; and
in response to the distance ratio not being an integer, determining a minimum positive integer larger than the distance ratio as the number of said portion of left eye viewpoints.

8. The method according to claim 5, wherein a number of left-eye viewpoint maps at the multiple left eye viewpoints is equal to a number of right-eye viewpoint maps at the multiple right eye viewpoints, a number of said portion of left eye viewpoints is equal to a number of said other portion of left eye viewpoints, and a number of said portion of right eye viewpoints is equal to a number of said other portion of right eye viewpoints, and
wherein said portion of the left eye viewpoints and said other portion of the left eye viewpoints comprise viewpoints adjacent to the viewpoint corresponding to the horizontal coordinate of the left eye, respectively, and are arranged successively according to a sequence of viewpoints in the display space, and
wherein said portion of right eye viewpoints and said other portion of right eye viewpoints comprise viewpoints adjacent to the viewpoint corresponding to the horizontal coordinate of the right eye, respectively, and are arranged successively according to the sequence of viewpoints in the display space.

9. A video communication method applied to a display terminal, comprising:
acquiring human eye positioning coordinate data of a viewer located at a display terminal, wherein the human eye positioning coordinate data comprises a horizontal coordinate of a left eye and a horizontal coordinate of a right eye of the viewer in a display space of the display terminal;
transmitting the human eye positioning coordinate data to an acquisition terminal;
obtaining left-eye viewpoint maps and right-eye viewpoint maps, the left-eye viewpoint maps comprising a left-eye viewpoint map at a viewpoint corresponding to the horizontal coordinate of the left eye in the display space, rendered by the acquisition terminal according to a current frame scene image acquired by the acquisition terminal and the human eye positioning coordinate data, the right-eye viewpoint maps comprising a right-eye viewpoint map at a viewpoint corresponding to the horizontal coordinate of the right eye in the display space, rendered by the acquisition terminal according to the current frame scene image acquired by the acquisition terminal and the human eye positioning coordinate data; and
performing display according to the obtained left-eye viewpoint maps and right-eye viewpoint maps.

10. The method according to claim 9, wherein the current frame scene image acquired by the acquisition terminal comprises current frame color images of the scene and current frame depth images of the scene acquired at multiple different viewing angles of the acquisition terminal.

11. The method according to claim 9, wherein said acquiring human eye positioning coordinate data of a viewer located at a display terminal comprises:
obtaining a human eye image comprising the left eye and the right eye of the viewer in the display space of the display terminal;
detecting, in the human eye image, regions of interest comprising the left eye and the right eye respectively to obtain a left-eye region image and a right-eye region image;
denoising the left-eye region image and the right-eye region image to obtain a left-eye denoised image and a right-eye denoised image;
performing a gradient calculation on the left-eye denoised image and the right-eye denoised image, respectively; and
determining a horizontal coordinate of a point with a largest number of straight line intersections in a gradient direction in a respective denoised image of the left-eye denoised image and the right-eye denoised image as a horizontal coordinate of an eye of the viewer in a respective direction.

12. The method according to claim 9, wherein the human eye positioning coordinate data of the viewer is acquired at a first moment, and the left-eye viewpoint maps further comprise left-eye viewpoint maps at multiple left eye viewpoints and the right-eye viewpoint maps further comprise right-eye viewpoint maps at multiple right eye viewpoints,
wherein horizontal coordinates to which a portion of left eye viewpoints of the multiple left eye viewpoints correspond are smaller than the horizontal coordinate of the left eye, and horizontal coordinates to which the other portion of left eye viewpoints correspond are larger than the horizontal coordinate of the left eye,
wherein horizontal coordinates to which a portion of right eye viewpoints of the multiple right eye viewpoints correspond are smaller than the horizontal coordinate of the right eye, and horizontal coordinates to which the other portion of right eye viewpoints correspond are larger than the horizontal coordinate of the right eye, and
wherein said performing display according to the obtained left-eye viewpoint maps and right-eye viewpoint maps comprises:
determining, based on human eye positioning coordinate data acquired at a second moment after the first moment, viewpoint maps at viewpoints corresponding to the human eye positioning coordinate data acquired at the second moment from the rendered left-eye viewpoint maps and right-eye viewpoint maps for display.

13. The method according to claim 12, wherein a number of said portion of left eye viewpoints depends on a moving distance between a horizontal coordinate of the left eye acquired at the second moment and a horizontal coordinate of the left eye acquired at the first moment during a previous frame period, the previous frame period represents a process of determining a viewpoint map at a corresponding viewpoint for display using a previous frame scene image before the current frame scene image.

14. The method according to claim 13, further comprising:
determining the number of said portion of left eye viewpoints by performing operations comprising:
determining a moving distance between a horizontal coordinate of the left eye acquired at the second moment and a horizontal coordinate of the left eye acquired at the first moment during a previous frame period;
dividing the moving distance by a spacing between adjacent viewpoints of a display presenting the display space to obtain a distance ratio;
in response to the distance ratio being an integer, determining the distance ratio as the number of said portion of left eye viewpoints; and
in response to the distance ratio not being an integer, determining a minimum positive integer larger than the distance ratio as the number of said portion of left eye viewpoints.

15. The method according to claim 12, wherein a number of left-eye viewpoint maps at the multiple left eye viewpoints is equal to a number of right-eye viewpoint maps at the multiple right eye viewpoints, a number of said portion of left eye viewpoints is equal to a number of said other portion of left eye viewpoints, and a number of said portion of right eye viewpoints is equal to a number of said other portion of right eye viewpoints,
wherein said portion of the left eye viewpoints and said other portion of the left eye viewpoints comprise viewpoints adjacent to the viewpoint corresponding to the horizontal coordinate of the left eye, respectively, and are arranged successively according to a sequence of viewpoints in the display space, and
wherein said portion of right eye viewpoints and said other portion of right eye viewpoints comprise viewpoints adjacent to the viewpoint corresponding to the horizontal coordinate of the right eye, respectively, and are arranged successively according to the sequence of viewpoints in the display space.

16. The method according to claim 12, wherein said determining, based on human eye positioning coordinate data acquired at a second moment after the first moment, viewpoint maps at viewpoints corresponding to the human eye positioning coordinate data acquired at the second moment from the rendered left-eye viewpoint maps and right-eye viewpoint maps for display comprises:
determining a first horizontal coordinate closest to the horizontal coordinate of the left eye acquired at the second moment from a horizontal coordinates corresponding to the rendered left-eye viewpoint maps, and a second horizontal coordinate closest to the horizontal coordinate of the right eye acquired at the second moment from horizontal coordinates corresponding to the rendered right-eye viewpoint maps; and
determining a left-eye viewpoint map to which the first horizontal coordinate corresponds and a right-eye viewpoint map to which the second horizontal coordinate corresponds as the viewpoint maps at viewpoints corresponding to the human eye positioning coordinate data acquired at the second moment for display.

17. (canceled)

18. A video communication device applied to a display terminal, comprising:
a camera configured to acquire human eye positioning coordinate data of a viewer located at the display terminal, wherein the human eye positioning coordinate data comprises a horizontal coordinate of a left eye and a horizontal coordinate of a right eye of the viewer in a display space of the display terminal;
a processor configured to transmit the human eye positioning coordinate data to an acquisition terminal, and configured to obtain left-eye viewpoint maps and right-eye viewpoint maps, the left-eye viewpoint maps comprising a left-eye viewpoint map at a viewpoint corresponding to the horizontal coordinate of the left eye in the display space, rendered by the acquisition terminal according to a current frame scene image acquired by the acquisition terminal and the human eye positioning coordinate data, the right-eye viewpoint maps comprising a right-eye viewpoint map at a viewpoint corresponding to the horizontal coordinate of the right eye in the display space, rendered by the acquisition terminal according to the current frame scene image acquired by the acquisition terminal and the human eye positioning coordinate data; and
a display configured to perform display according to the obtained left-eye viewpoint maps and right-eye viewpoint maps.

19. A computing device, comprising a memory and a processor, the memory storing a computer program which, when executed by the processor, causes the processor to carry out steps of the method according to claim 1.

20. A non-transitory computer-readable storage medium, the non-transitory computer-readable storage medium storing a computer program which, when executed by a processor, causes the processor to execute the method according claim 1.

21. A computer program product comprising a computer program which, when executed by a processor, implements steps of the method according to claim 1.
